(19) United States
(12) Patent Application Publication
(10) Pub. No.: US 2009/0236931 A1
(43) Pub. Date: Sep. 24, 2009

(54) SHAPE MEMORY ALLOY ACTUATOR

(75) Inventor: Masaya TAKAHASHI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/403,725

(22) Filed: Mar. 13, 2009

(30) Foreign Application Priority Data
Mar. 19, 2008 (JP) JP 2008-070657

(51) Int. Cl. H02N 10/00

(52) U.S. Cl. 310/306

(57) ABSTRACT

A shape memory alloy actuator includes a wire material of a shape memory alloy of which, one end is fixed, a mobile object which is mechanically coupled with the other end of the wire material, a bias applying member which applies an external force on the mobile object, in a direction in which the wire material of the shape memory alloy elongates by cooling, and an attraction force generating mechanism which is disposed at a position facing the bias applying member via the mobile object, and which generates an attraction force acting in a direction same as a direction of the external force applied by the bias applying member to the mobile object. A position of the mobile object is changed by changing a length of the wire material of the shape memory alloy by changing a temperature of the wire material by supplying an electric power to the wire material.

### CROSS-REFERENCE TO RELATED APPLICATION

The present application is based upon and claims the benefit of priority from the prior Japanese Patent Application No. 2008-070657 filed on Mar. 19, 2008; the entire contents of which are incorporated herein by reference.

### BACKGROUND OF THE INVENTION

1. Field of the Invention

The present invention relates to a shape memory alloy actuator which drives a mobile object by a contractive force of a wire material of a shape memory alloy, and a stress of a bias spring.

2. Description of the Related Art

A shape memory alloy undergoes a phase transition due to a change in a temperature, and has a change of shape. An actuator in which, the shape change of the shape memory alloy is used is superior in characteristics such as a small size and a light weight.

For instance, in Japanese Patent Application Laid-open Publication No. Sho 61-19980, a structure in which, one end of a wire material of a shape memory alloy is let to be a fixed end and the other end is let to be a movable end has been shown. In this invention, a technology in which the movable end is driven by a stress of a bias spring and a contraction which is generated when a length of the wire material of the shape memory alloy is changed by heating by supplying an electric power through an electroconductive wire connected to both ends of the wire material of the shape memory alloy has been disclosed.

In the abovementioned prior art, a mobile object is moved by the stress of the bias spring and the contraction of the shape memory alloy in the form of a wire. In this case, at the time of driving the mobile object by the contraction of the wire material of the shape memory alloy, the shape memory alloy is heated and made to contract by heating. Consequently, by increasing an amount of electric power supplied for heating, a rapid response is possible. Moreover, an arrangement is made such that, at the time of driving the mobile object by elongation of the shape memory alloy, the mobile object moves by a stress applied by an action of regaining of an original form by the bias spring due to stopping the supply of electric power.

In the arrangement of the prior art, with an elongation of the wire material of the shape memory alloy, a bias of the bias spring decreases. Therefore, with the decrease in the bias of the bias spring, a speed at which the shape memory alloy elongates declines. Moreover, for making the size small, when the cooling is by natural heat release, the decrease in the speed of elongation of the shape memory alloy becomes even more remarkable.

### SUMMARY OF THE INVENTION

The present invention is made in view of the abovementioned circumstances, and an object of the present invention is to prevent the decline in the speed of a mobile object drive when the shape memory alloy elongates, by making an arrangement such that further increased attraction force acts on the mobile object in a direction in which the shape memory alloy elongates, in a shape memory alloy actuator which drives the mobile object by a contraction of a wire material of a shape memory alloy and a stress of a bias spring.

To solve the abovementioned issues and to achieve the object, according to the present invention, there is provided a shape memory alloy actuator including

a wire material of a shape memory alloy of which, one end is fixed,

a mobile object which is mechanically coupled with the other end of the wire material of the shape memory alloy, a bias applying member which applies an external force on the mobile object, in a direction in which the wire material of the shape memory alloy elongates by cooling, and

an attraction force generating mechanism which is disposed at a position facing the bias applying member via the mobile object, and which generates an attraction force acting in a direction same as a direction of the external force applied by the bias applying member to the mobile object, and

a position of the mobile object is changed by changing a length of the wire material of the shape memory alloy by changing a temperature of the wire material of the shape memory alloy by supplying an electric power to the wire material of the shape memory alloy.

According a preferable aspect of the present invention, it is desirable that a strength of the attraction force generated by the attraction force generating mechanism is attenuated with an increase in a distance between the attraction force generating mechanism and the mobile object.

According to a preferable aspect of the present invention, it is desirable that the shape memory alloy actuator further includes a mobile object regulating member which regulates a change in position of the mobile object such that a distance between the mobile object and the attraction force generating mechanism is not less than a predetermined distance.

According a preferable aspect of the present invention, it is desirable that in a range of movement of the mobile object, a sum of the external force applied by the bias applying member and the attraction force of the attraction force generating mechanism is substantially constant.

According to a preferable aspect of the present invention, it is desirable that the attraction force of the attraction force generating mechanism is a magnetic force.

According to a preferable aspect of the present invention, it is desirable that the attraction force of the attraction force generating mechanism is an electrostatic force.

According to a preferable aspect of the present invention, it is desirable that the mobile object includes a magnetic body, and the attraction force generating mechanism is formed by a permanent magnet.

According to a preferable aspect of the present invention, it is desirable that the mobile object has a permanent magnet, and the attraction force generating mechanism is formed of a magnetic body.

According to a preferable aspect of the present invention, it is desirable that the attraction force generating mechanism includes a permanent magnet, and the permanent magnet is covered by a magnetic body.

According to a preferable aspect of the present invention, it is desirable that the magnetic body is cylinder-shaped.

### BRIEF DESCRIPTION OF THE DRAWINGS

FIG. 1 is a perspective view of a first embodiment;

FIG. 2 is a diagram explaining a structure and an operation of the first embodiment;

FIG. 3 is another diagram explaining the structure and the operation of the first embodiment;

FIG. 4 is still another diagram explaining the structure and the operation of the first embodiment;

FIG. 5 is a diagram explaining a relationship of a force acting on a mobile object and a position thereof;

FIG. 6 is a diagram explaining a structure and an operation of a second embodiment;

FIG. 7 is another diagram explaining the structure and the operation of the second embodiment;

FIG. 8 is still another diagram explaining the structure and the operation of the second embodiment;

FIG. 9 is a diagram explaining a structure of a third embodiment;

FIG. 10 is a diagram explaining an attraction force generating mechanism of the third embodiment; and

FIG. 11 is a perspective view of the attraction force generating mechanism of the third embodiment.

### DETAILED DESCRIPTION OF THE PREFERRED EMBODIMENTS

Exemplary embodiments of a shape memory alloy actuator according to the present invention will be described below in detail by referring to the accompanying diagrams. However, the present invention is not restricted by the embodiments described below.

### First Embodiment

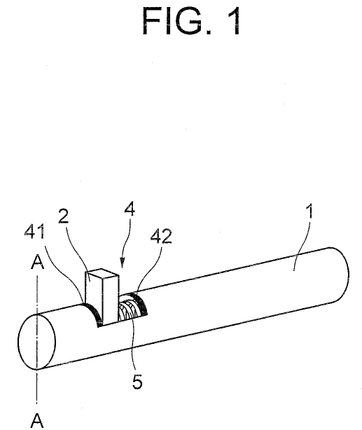

FIG. 1 is a perspective view of a first embodiment of the shape memory alloy actuator according to the present invention.

In FIG. 1, a cylinder 1 has a groove 4. A mobile object 2 which is a driving section of the actuator is protruded outside through the groove 4. A first stopper 41 and a second stopper 42 which regulate a range of driving of the mobile object 2 are installed at two ends of the groove 4. It is also possible to drive a predetermined movable portion by connecting the mobile object 2 to the movable portion on the outside.

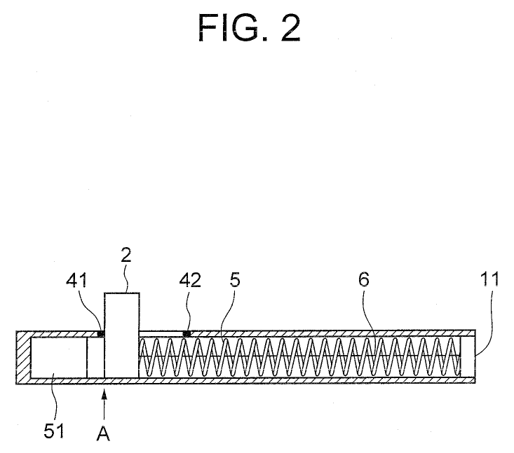

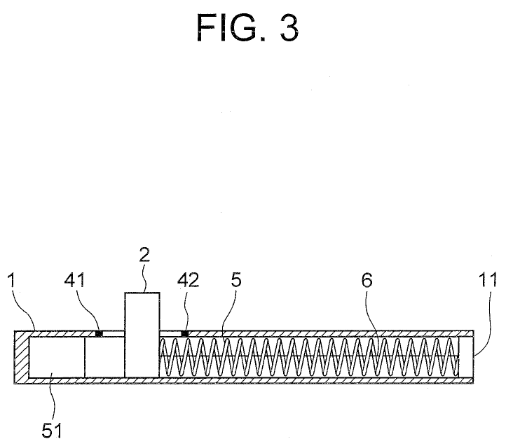

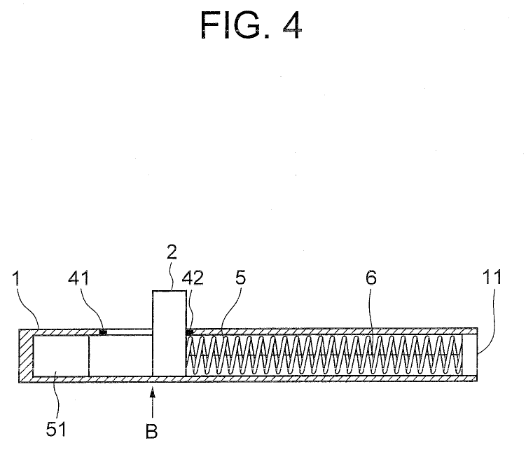

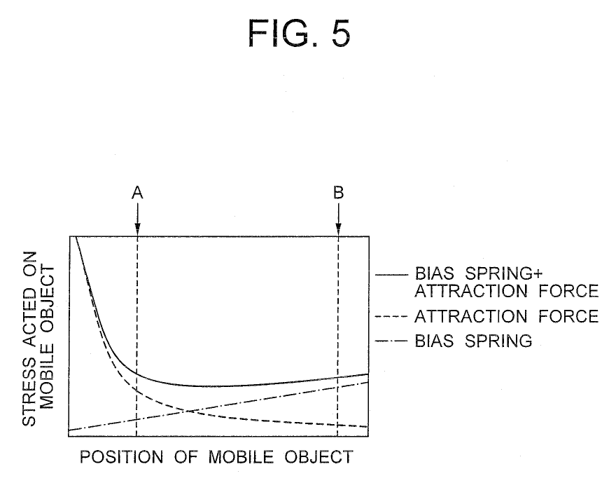

FIG. 2, FIG. 3, and FIG. 4 are cross-sectional views taken along a line A-A of a structure shown in FIG. 1 in which, a position change due to a state of a shape memory alloy wire 6 is shown. Moreover, FIG. 5 is a graph in which, an outline of a position change of the mobile object 2 and a stress acting on the mobile object 2 from a source other than the shape memory alloy wire 6 is shown.

The first stopper 41 and the second stopper 42 provided at two ends of the groove 4 described above stop the mobile object 2 at these positions. The mobile object 2 is exposed to an outside of the cylinder 1. Moreover, the shape memory alloy wire 6 is connected to the mobile object 2. The shape memory alloy wire 6 is passed through an interior of a bias spring 5, and is fixed to a wire fixing member 11 which is at an end portion of the cylinder 1. The mobile object 2 is in a state of a stress being applied in a leftward direction by the bias spring 5.

An attraction force generating mechanism 51 is provided to a side facing the wire fixing member 11 of the cylinder, at a predetermined distance from the first stopper 41. An attraction force in a leftward direction of a paper surface is applied on the mobile object 2 by the attraction force generating mechanism 51. In the first embodiment, the attraction force generating mechanism 51 is let to be an electromagnetic coil, and the mobile object 2 is let to be a magnetic body.

FIG. 2 shows a state in which the mobile object 2 stopped at a position of the first stopper 41 by the stress of the bias spring 5 and the attraction force of the attraction force generating mechanism 51. In this state, the shape memory alloy wire 6 is unstrained with an electric power not being supplied by a power supply unit which is omitted in the diagram. The mobile object 2 is in a state of being stopped at the first stopper 41 with the stress in the leftward direction of the paper surface being applied by the bias spring 5. For the sake of description, a position at which the mobile object 2 is stopped at the first stopper 41 is let to be a position A.

FIG. 3 shows a state in which the mobile object 2 has undergone a position change due to heating by supplying an electric power to the shape memory alloy wire 6 by the power supply unit which is omitted in the diagram. When the electric power is supplied, the shape memory alloy wire 6 undergoes a phase transition and contracts. A contractive force of the shape memory alloy wire 6 being larger than the stress of the bias spring 5 and the attraction force of the attraction force generating mechanism 51, the mobile object 2 changes a position in a direction of contraction of the shape memory alloy wire 6.

FIG. 4 shows a case in which, the mobile object 2 is stopped at the second stopper 42 by increasing the heating by increasing the supply of electric power to be more than in FIG. 3. Due to the increase in the heating, an amount of contraction of the shape memory alloy wire 6 increases, and the mobile object 2 moves in the direction of contraction of the shape memory alloy wire 6, thereby changing the position to the position of the second stopper 42, and stops. For the sake of description, the position at which the mobile object 2 has stopped at the stopper 42 is let to be a position B.

In this manner, when the shape memory alloy wire 6 is made to contract by heating, the mobile object 2 moves in order of positions shown in diagrams from FIG. 2, FIG. 3, and FIG. 4 respectively. Conversely, when the shape memory alloy wire 6 is made to elongate by cooling, the mobile object 2 moves in order of position shown in diagrams FIG. 4, FIG. 3, and FIG. 2 respectively. The stress acting in the leftward direction of the paper surface by the bias spring 5 and the attraction force acting in the leftward direction of the paper surface by the attraction force generating mechanism 51 act all the time, whether the shape memory alloy wire 6 is made to contract by heating or is made to elongate by cooling. When the position of the mobile object 2 is same, the same amount of force acts on the mobile object 2 during any of the two operations namely the contraction by heating and elongation by cooling. Moreover, when a resistance such as friction is ignored, the external force acting on the mobile object 2 from the bias spring 5 and the attraction force generating mechanism 51 may be considered to be the force acting on the shape memory alloy wire 6.

FIG. 5 is a graph in which, the position of the mobile object 2, the stress of the bias spring 5 which acts on the mobile object 2, the attraction force from the attraction force generating mechanism 51, and a sum of the stress of the bias spring 5 and the attraction force from the attraction force generating mechanism 51 are shown. In FIG. 5, a solid line shows the resultant of the stress of the bias spring 5 and the attraction force from the attraction force generating mechanism 51, a dashed line shows the attraction force from the attraction force generating mechanism 51, and an alternate dotted and dashed line shows the stress of the bias spring 5. A and B shown by arrows in FIG. 5 shows the positions A and B of the mobile object 2 shown in FIG. 2 and FIG. 4. In the first embodiment, since the first stopper 41 and the second stopper 42 which regulate the driving of the mobile object 2 are installed, a space between A and B becomes an area in which the mobile object 2 is movable.

As the position of the mobile object 2 goes on changing in the leftward direction of the paper surface, the stress of the bias spring 5 acting on the mobile object 2 shown by the alternate dotted and dashed line in FIG. 5 goes on decreasing. As it is shown in FIG. 2, FIG. 3, and FIG. 4, a direction of the change in the position from the position of B to the position of A is a direction of movement when the shape memory alloy wire 6 is elongated due to cooling.

Next, as the position of the mobile object 2 goes on changing in the leftward direction of the paper surface, the attraction force of the attraction force generating mechanism 51 shown by the dashed line goes on increasing. A relationship between the attraction force of the attraction force generating mechanism 51 and the position, and a relationship between the stress of the bias spring 5 and the position are mutually opposite.

In the conventional driving, when the shape memory alloy wire 6 is elongated by cooling, only the stress of the bias spring 5 acts on the mobile object 2, and the stress acting on the mobile object 2 decreases gradually, and a response speed decreases.

When both the stress of the bias spring 5 and the attraction force of the attraction force generating mechanism 51 act in the same direction, the resultant of the stress and the attraction force is maintained to be almost constant as shown by the solid line in FIG. 5, even when the mobile object 2 changes the position from the position B to position A. It is possible to compensate the decline in the stress of the bias spring 5 by the attraction force of the attraction force generating mechanism 51. Consequently, in the driving when the shape memory alloy wire 6 is elongated by cooling, even when the mobile object 2 changes the position from the position B to position A, since it is possible to prevent the decrease in the force which changes the position of the mobile object 2, and to make a constant force act thereon, the response speed is secured, and a stable response is possible.

In the first embodiment, the attraction force generating mechanism 51 is let to be an electromagnetic coil. Even when the attraction force generating mechanism 51 and the mobile object 2 are connected electrically, and an electrostatic attraction force is used, it is possible to achieve the same effect.

Whichever of the magnetic force and the electrostatic attraction force is used by the attraction force generating mechanism 51, as the distance between the mobile object 2 and the attraction force generating mechanism 51 goes on increasing, the attraction force in the leftward direction of the paper surface in FIG. 2 applied to the mobile object 2 decreases. With the increase in the distance between the mobile object 2 and the attraction force generating mechanism 51, the stress of the bias spring 5 applied to the mobile object 2 increases. Whichever of the magnetic force and the electrostatic attraction force is used, it is possible that the resultant force exerted on the mobile object 2 by the bias spring 5 and the attraction force generating mechanism 51 is almost constant.

For instance, as shown in FIG. 5, in the first embodiment, the attraction force from the attraction force generating mechanism 51 at the position A is set to be smaller than the stress of the bias spring 5 at the position B. However, an arrangement is not restricted to such arrangement, and the stress of the bias spring 5 and the attraction force from the attraction force generating mechanism 51 may be set to be such that the resultant of the stress of the bias spring 5 and the attraction force of the attraction force generating mechanism 51 shown by the solid line is almost constant between the position A and the position B.

Moreover, a setting may be carried out such that the first stopper 41 and the second stopper 42 are installed such that the movable object 2 is movable in a range in which the resultant (the sum) of the stress of the bias spring 5 and the attraction force from the attraction force generating mechanism 51 is substantially constant.

A movable body regulating member corresponds to the first stopper 41. As shown in FIG. 5, nearer the position to the attraction force generating mechanism 51, the attraction force increases rapidly. By securing the distance between the attraction force generating mechanism 51 and the mobile object 2 by the stopper 41, and by controlling the maximum value of the attraction force, a stable force within the area of movement is secured.

### Second Embodiment

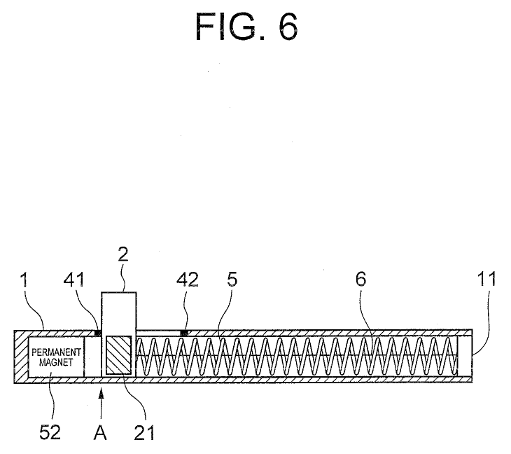

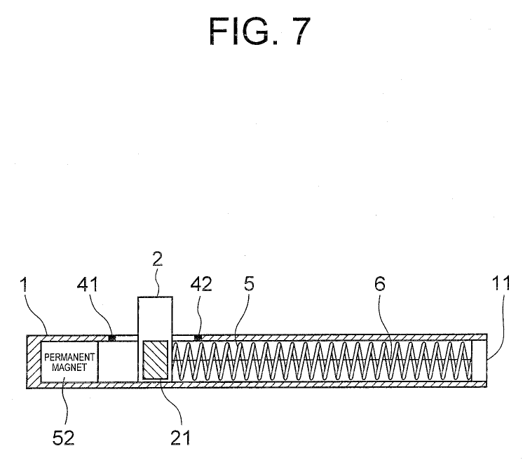

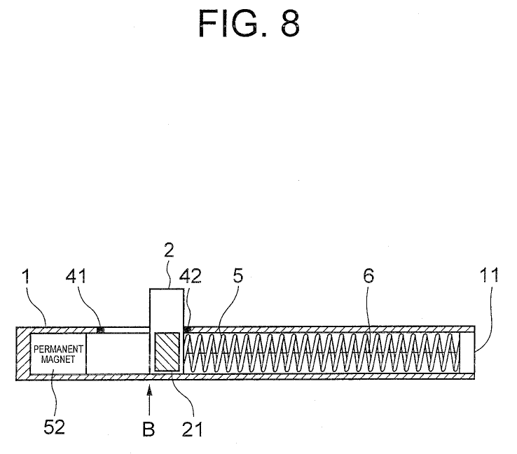

FIG. 6, FIG. 7, and FIG. 8 are diagrams showing a structure and an operation of a second embodiment of the shape memory alloy actuator according to the present invention.

FIG. 6, FIG. 7, and FIG. 8 are diagrams corresponding to cross-sectional views taken along a line A-A in FIG. 1, of the second embodiment in which, a position change of the mobile object 2 due to the state of the shape memory alloy wire 6 is shown. FIG. 6, FIG. 7, and FIG. 8 are similar to FIG. 2, FIG. 3, and FIG. 4 respectively; with regard to the position change of the mobile object 2 in the state of the shape memory alloy wire 6. Consequently, the description of similar structures is omitted.

In FIG. 6, FIG. 7, and FIG. 8, the mobile object 2 has a magnetic body 21 at an interior. As an attraction force generating mechanism, a permanent magnet 52 is installed, and the attraction force which acts on the mobile object 2 and the permanent magnet 52 is used. As shown in FIG. 5, a sum of the stress of the bias spring 5 and the attraction force from the permanent magnet 52 achieves almost a constant force at any position, in the area of movement of the mobile object 2. Consequently, even when the mobile object 2 is driven by the shape memory alloy wire 6 being elongated by cooling, it is possible to achieve an effect of a stable response.

In FIG. 6, FIG. 7, and FIG. 8, a part of the mobile object 2 is magnetic due to the magnetic body 21. As a matter of course, the entire mobile object 2 may be a magnetic body. Moreover, it is possible to achieve the same effect even when the magnetic body 21 is a permanent magnet, and the permanent magnet 52 is a magnetic body. Further, it is possible to achieve a similar effect by letting both the magnetic body 21 and the permanent magnet 52 to be permanent magnets, and disposing such that the mutual attraction force acts.

### Third Embodiment

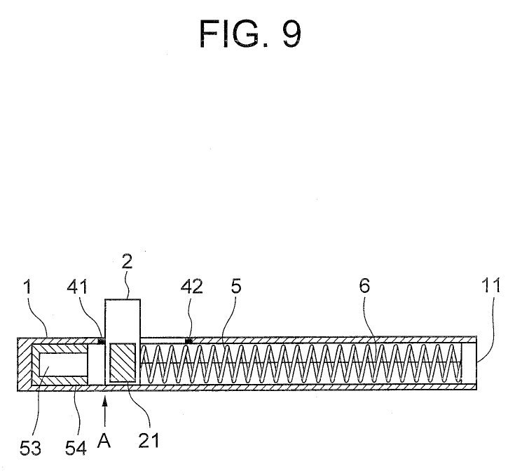

FIG. 9 is a diagram corresponding to the cross-sectional view along the line A-A in FIG. 1, of a third embodiment. The position change of the mobile object 2 in the state of the shape memory alloy wire 6 being similar to the position change in the first embodiment and the second embodiment, a description thereof is omitted. Moreover, description of structures similar to the structures in the first embodiment and the second embodiment is omitted.

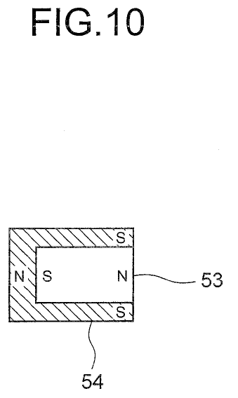

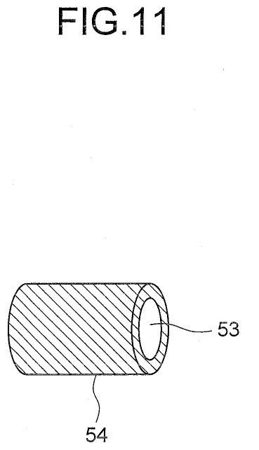

FIG. 9 shows that an attraction force generating mechanism is formed by a permanent magnet 53 and a magnetic body 54. FIG. 10 shows only the permanent magnet 53 and the magnetic body 54 of the attraction force generating mechanism of the third embodiment, and FIG. 11 is a perspective view of FIG. 10.

As shown in FIG. 10, a right side of a paper surface of the permanent magnet 53 has a north (N) polarity and a left side of the paper surface has a south (S) polarity. The magnetic body 54 which covers the permanent magnet 53 is polarized due to an effect of the permanent magnet 53, and the left side of the paper surface becomes the N pole and the right side of the paper surface becomes the S pole. According to the structure shown in FIG. 10, the permanent magnet 53 and the magnetic body 54 which are the attraction force generating mechanism have a structure in which, the N pole and the S pole are near, and a magnetic flux density becomes higher toward the mobile object 2. In other words, when the attraction force generating mechanism has the same size, a magnetic force larger than a magnetic force in the second embodiment is created, and a magnetic field is generated in a rightward direction of the paper surface with a high efficiency. In this manner, by generating the magnetic field toward the mobile object 2 at a high efficiency, a reduction in size of the attraction force generating mechanism is possible.

Moreover, as shown in FIG. 11, by making the magnetic body 54 to be circular cylindrical shaped, it is possible to dispose by inserting into the circular cylinder. The bias spring 5 being coil-shaped, accommodating the entire actuator inside the circular cylinder is advantageous for the size reduction. By making the magnetic body 54 to be circular cylindrical shaped, it is possible to reduce a size of the overall actuator.

As it has been described above, a shape memory alloy actuator according to the present invention is useful for a shape memory alloy actuator which drives a mobile object by a contractive force of a wire material of a shape memory alloy and a stress of a bias spring, and in particular, is appropriate for an actuator which necessitates a stable drive when (being) elongated due to cooling.

By making an arrangement such that further stronger attraction force acts on a mobile object in a direction in which the shape memory alloy is elongated, the shape memory alloy actuator according to the present invention shows an effect of preventing a decrease in a speed of driving the mobile object when the shape memory alloy elongates.

What is claimed is:

1. A shape memory alloy actuator comprising:
a wire material of a shape memory alloy of which, one end is fixed;
a mobile object which is mechanically coupled with the other end of the wire material of the shape memory alloy;
a bias applying member which applies an external force on the mobile object, in a direction in which the wire material of the shape memory alloy elongates by cooling; and
an attraction force generating mechanism which is disposed at a position facing the bias applying member via the mobile object, and which generates an attraction force acting in a direction same as a direction of the external force applied by the bias applying member to the mobile object, wherein
a position of the mobile object is changed by changing a length of the wire material of the shape memory alloy by changing a temperature of the wire material of the shape memory alloy by supplying an electric power to the wire material of the shape memory alloy.

2. The shape memory alloy actuator according to claim 1, wherein a strength of the attraction force generated by the attraction force generating mechanism is attenuated with an increase in a distance between the attraction force generating mechanism and the mobile object.

3. The shape memory alloy actuator according to claim 1, further comprising:
a mobile object regulating member which regulates a change in position of the mobile object such that a distance between the mobile object and the attraction force generating mechanism is not less than a predetermined distance.

4. The shape memory alloy actuator according to claim 3, wherein in a range of movement of the mobile object, a sum of the external force applied by the bias applying member and the attraction force of the attraction force generating mechanism is substantially constant.

5. The shape memory alloy actuator according to claim 4, wherein the attraction force of the attraction force generating mechanism is a magnetic force.

6. The shape memory alloy actuator according to claim 5, wherein
the mobile object includes a magnetic body, and
the attraction force generating mechanism is formed by a permanent magnet.

7. The shape memory alloy actuator according to claim 6, wherein the attraction force generating mechanism includes a permanent magnet, and the permanent magnet is covered by a magnetic body.

8. The shape memory alloy actuator according to claim 7, wherein the magnetic body is cylinder-shaped.

9. The shape memory alloy actuator according to claim 5, wherein
the mobile object includes a permanent magnet, and
the attraction force generating mechanism is formed by a magnetic body.

10. The shape memory alloy actuator according to claim 3, wherein the attraction force of the attraction force generating mechanism is an electrostatic force.

11. The shape memory alloy actuator according to claim 2, wherein the attraction force of the attraction force generating mechanism is a magnetic force.

12. The shape memory alloy actuator according to claim 11, wherein
the mobile object has a magnetic body, and
the attraction force generating mechanism is a permanent magnet.

13. The shape memory alloy actuator according to claim 12, wherein the attraction force generating mechanism includes a permanent magnet, and the permanent magnet is covered by a magnetic body.

14. The shape memory alloy actuator according to claim 13, wherein the magnetic body is cylinder-shaped.

15. The shape memory alloy actuator according to claim 11, wherein
the mobile object includes a permanent magnet, and
the attraction force generating mechanism is formed by a magnetic body.

16. The shape memory alloy actuator according to claim 2, wherein the attraction force of the attraction force generating mechanism is an electrostatic force.
